(19) United States
(12) Patent Application Publication
(10) Pub. No.: US 2002/0099769 A1
(43) Pub. Date: Jul. 25, 2002

(54) Server system for distributing information to portable mobile information terminal in specific area

(76) Inventors: Yutaka Yasui, Kawasaki (JP); Norio Murakami, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/900,332

(22) Filed: Jul. 6, 2001

(30) Foreign Application Priority Data
Jan. 23, 2001 (JP) 2000-14707

(51) Int. Cl. G06F 15/16

(52) U.S. Cl. 709/203

(57) ABSTRACT

The server system comprises a data base for storing the information of a specific area where the information distribution service is provided to registered users of the portable mobile information terminals, the prepared information to be distributed and the distribution conditions thereof provided by a sponsor, and each registered user and the conditions for receiving the prepared information. The position information is received from a portable mobile information terminal, and it is determined whether the portable mobile information terminal is located in the specific area and, in the case where the portable mobile information terminal is located in the specific area, individual and specific information satisfying both the distribution conditions and the receiving conditions are distributed to the particular portable mobile information terminal.

### BACKGROUND OF THE INVENTION

1. Field of the Invention

The present invention relates to an information distribution system or, in particular, to an information distribution server system configured to distribute advertisement and publicity information, etc. closely related to the area where a user is located of each portable mobile information terminal such as a portable telephone having the function of connecting to the Internet.

2. Description of the Related Art

In recent years, the extension of the Internet has made it possible to acquire various information easily and rapidly from wide areas of the world. Various businesses and services, public or commercial, have been conducted on the internet utilizing this convenience. For example, an information distribution service is widely known, in which a service user registers his preferences or the like in a server system of a service provider in advance through the Internet, and the server system distributes only the information suited to the contents of the registration to the terminal connected to the Internet. A mailing list for distributing information on new products, i.e. a mail magazine, is a case in point.

Advertisements play a crucial role in business. With the spread of the portable telephony connectable to the internet, a new advertisement distribution system has become available for distributing advertisements to cellular phones or PHSs. In view of this, demand is high for an information distribution system utilizing the features of the portable mobile information terminals, including cellular phones or PHSs, to provide advertisement information taking the time and the place of terminal users into consideration, advantageously for both sponsors and information receivers.

Nevertheless, the conventional advertisement distribution system for portable mobile information terminals has the following restraints:

(1) The information is distributed by the public mobile communication network to all the subscribers to a particular network without discrimination or only to the subscribers requiring the announcement.

(2) The announced information corresponding to the position information of a subscriber is a combination of the GPS (global positioning system) information from the subscriber or the position information acquired by other means and the announced information (a map, for example), and the service is offered only to the subscribers.

For this reason, it has been impossible to announce carefully selected information aimed at only the persons located at a predetermined time point in a specific area, where the information provided by a sponsor has a special effect, and where the terminal users in the particular area can utilize the particular information most effectively.

### SUMMARY OF THE INVENTION

In view of the problem points described above, the object of the present invention is to provide an information distribution server system capable of announcing the information closely related to a specific area to a plurality of persons located in the particular area.

Another object of this invention is to provide a server system having a data base for the information required of the server system which is configured of the geophysically-limited distribution information from sponsors, the user registration information based on the preferences of the users and the information on the present position from a portable mobile information terminal connectable to the Internet.

According to this invention, there is provided a server system for distributing information to the portable mobile information terminals in a specific area, comprising a first data base for storing the information of the specific area where the information distribution service is offered to the registered users of portable mobile information terminals, a second data base for storing the prepared information to be distributed supplied by sponsors and the conditions for distribution of the prepared information, a third data base for storing the registered users and the conditions for receiving the prepared information, means for receiving the position information of the registered users existing in the specific area from the portable mobile information terminals of the particular users, determining means for determining whether the received position information is located in the specific area stored in the first data base, and information distribution means by which the distribution information satisfying the distribution conditions stored in the second data base and the receiving conditions of the users stored in the third data base are distributed to the portable mobile information terminals of the users determined to be located in the area by the determining means.

The position information received from a portable mobile information terminal is configured with the latitude/longitude information of the particular portable mobile information terminal or the base station information (converted to the latitude/longitude information) of the radio area where the particular portable mobile information terminal is located. The server system further comprises area determining means for illustrating the specific area using a simple figure and storing the illustration in the first data base as area information represented by the latitude and longitude, the determining means using, for determination, the latitude/longitude information received from the portable mobile information terminal.

According to this invention, the information closely related to the area in which the portable mobile information terminal of the registered user requesting the information distribution is located is distributed to the registered user. In the case where a registrant desires to obtain the distribution of information on the bargain sale at a specific store or other event information, therefore, the information can be distributed only to the registrants located in the neighborhood of the particular store. As a result, the information from a store located in the neighborhood of Shibuya Station in Tokyo, for example, is not required to be transmitted to the registrants located in Kyushu or Hokkaido. Nor do the registrants receive useless information. In this way, a great effect of announcement can be expected of the sponsors, while at the same time making it possible to supply proper and useful information to the registrants.

### BRIEF DESCRIPTION OF THE DRAWINGS

The present invention will be more clearly understood from the description as set forth below with reference to the accompanying drawings.

FIG. 1 is a diagram showing an example of configuration of a network system to which the present invention is applicable.

FIG. 2 is a diagram showing an example of the sequence for the service registration by a terminal user.

FIGS. 3A and 3B are diagrams showing an example of the sequence for an information distribution request by a sponsor.

FIGS. 4A and 4B are diagrams showing an example of the sequence for changing the service contents, etc. by a terminal user.

FIG. 5A is a diagram showing an example (1) of the registration menu screen on a portable mobile information terminal.

FIG. 5B is a diagram showing an example (2) of the registration menu screen on a portable mobile information terminal.

FIG. 6 is a diagram showing an example (3) of the registration menu screen on a portable mobile information terminal.

FIG. 7 is a diagram showing an example of a service registration table on a server system.

FIG. 8 is a diagram showing an example of a position information table on a server system.

FIG. 9 is a diagram showing an example (1) using a rectangular area as an area to which information distribution is intended for.

FIG. 10A is a diagram showing an example (2) using a rectangular area as an area to which information distribution is intended for.

FIG. 10B is a diagram showing an example (3) using a rectangular area as an area to which information distribution is intended for.

FIG. 10C is a diagram showing an example (4) using a rectangular area as an area to which information distribution is intended for.

FIG. 11A is a diagram showing an example (1) using a circular area as an area to which information distribution is intended for.

FIG. 11B is a diagram showing an example (2) using a circular area as an area to which information distribution is intended for.

FIG. 11C is a diagram showing an example (3) using a circular area as an area to which information distribution is intended for.

FIG. 12 is a diagram showing an example (1) of configuration of a server system according to this invention.

FIG. 13 is a diagram showing an example (2) of configuration of a server system according to this invention.

FIG. 14 is a diagram showing an example (1) of the control flow of a server system according to this invention.

FIGS. 15A and 15B are diagrams showing an example (2) of the control flow of a server system according to this invention.

FIG. 16 is a diagram showing an example (3) of the control flow of a server system according to this invention.

FIG. 17 is a diagram showing an example (4) of the control flow of a server system according to this invention.

FIG. 18 is a diagram showing an example (5) of the control flow of a server system according to this invention.

### DESCRIPTION OF THE PREFERRED EMBODIMENTS

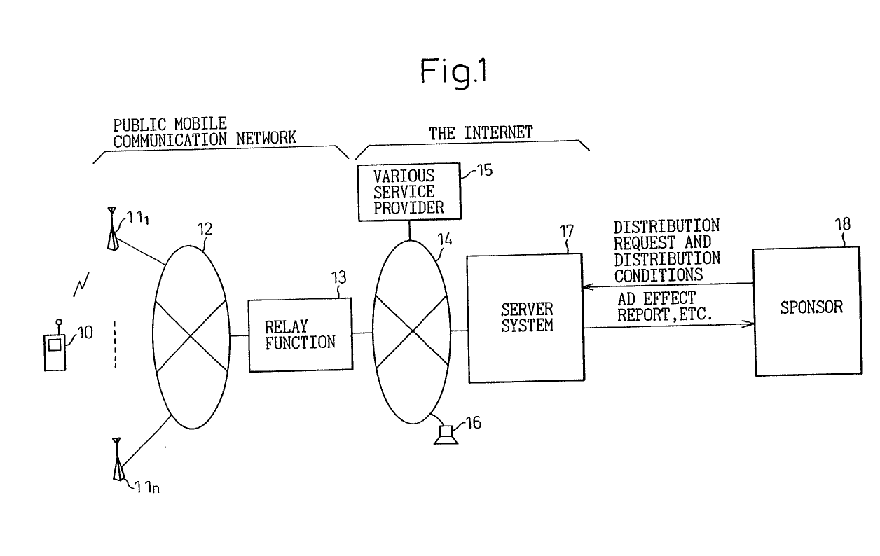

FIG. 1 shows an example of a network system configuration according to this invention.

In FIG. 1, a portable mobile information terminal 10 such as a cellular phone, PHS, or a PDA has the functions of voice communication and data communication within a public mobile communication network 12 on the one hand and is equipped with also the function as the Internet connecting terminal (the functions of WWW access and display of data including characters, static images, dynamic images, voice, music, etc., reproducing the voice signal and transmitting/receiving electronic mails). When performing the communication, the portable mobile information terminal 10 is connected to the public mobile communication network 12 through base stations 111 to 11n in each radio area where the terminal 10 exists.

The Internet 14 is the ordinary one for transferring packet data using the TCP/IP protocol. A relay function 13 acts as a gateway for interfacing between the public mobile communication network 12 for channel exchange mainly for voice communication and the Internet 14 for exchanging packets mainly for data communication.

A service provider 15 is configured of a server or the like operated and managed by an ordinary ISP (Internet service provider), and provides the web service (HTTP) and the E-mail service (SMTP, POP) to subscribers. By the way, the terminal 16 indicates a personal computer connected to the Internet 14 through the public mobile communication network 12 or an OCN (Open Computer Network) channel from an office network or the like.

The server system 17 is the one constructed by this invention, and is an information distribution server system for distributing information closely related to a specific radio area to a plurality of persons existing in the particular area, i.e. each user of the portable mobile information terminal 10, as described later. The server system 17 has a data base made up of the geophysically-limited prepared information from the sponsor 18 described later, the user registration information based on the preferences, etc. of each terminal user, and the information on the current position from the portable mobile information terminal connectable to the Internet.

The server system 17 has all of the various functions of the Internet server operated and managed by the ISP 15 described above, and by using the function of providing various Internet services and various processing functions for realizing such Internet services, provides an appropriate service to each user of the portable mobile information terminal 10 accessing through the Internet 14 and the public mobile communication network 12.

The sponsor 18 provides the advertisement and publicity information in a limited area of advertisement according to this invention. The information provider 18 includes, for example, department stores or owners of retail stores in the specific area as well as ordinary advertisement and publicity agencies. These entities request the server system 17 to distribute their advertisement and publicity information by designating the categories and preferences of the users of the portable mobile information terminals 10 desirous of receiving the distribution of the advertisement and publicity information from the particular entities, the specific area, district or radio area, and various other distribution conditions such as the distribution time, time zone, etc.

By the way, the range covered by the public mobile communication network and the Internet in the ordinary sense of the words are shown in the upper portion of FIG. 1.

As described above, the services are provided according to this invention in such a manner that the information which the sponsor 18 is desirous of distribution and coincides with the preferences of the terminal users are automatically distributed by the server system 17 to the portable mobile information terminals 10 in a designated area. Specifically,

(1) The user of the portable mobile information terminal 10 registers, in the data base of the server system 17, the desire to receive the information distribution service, the minimum information of the user (male or female and age, for example), the contents of the desired information (category of the information, for example) and other receiving conditions according to a predetermined procedure.

(2) The sponsor 18 registers, in the data base of the server system 17, various distribution conditions including, in addition to the designation of the information distribution area, such as the year and date and the time zone of distribution, the user category providing the destination of distribution, the preferences of the users, the type of the information providing means such as the web service, and the type of the information transmission medium such as voice or dynamic image.

(3) The server system 17 determines the distribution conditions designated by the sponsor 18 and the receiving conditions proposed by the terminal user, and among those portable mobile information terminals 10 in registration, extracts a portable mobile information terminal meeting the particular conditions and the receiving conditions thus determined. Further, only the portable mobile information terminals 10 existing in the area designated by the sponsor 18 are extracted, and individual specific information are distributed to each terminal user. As a result, the information distribution having a high announcing effect is made possible for both the information distributor and the information distributee.

The contents of the process in (1) to (3) described above will be explained in detail with reference to the corresponding drawings. By the way, to facilitate the understanding of the invention, first, reference will be made to the services according to an embodiment of the invention, and then the configuration of the server system 17 for realizing the services will be explained in detail.

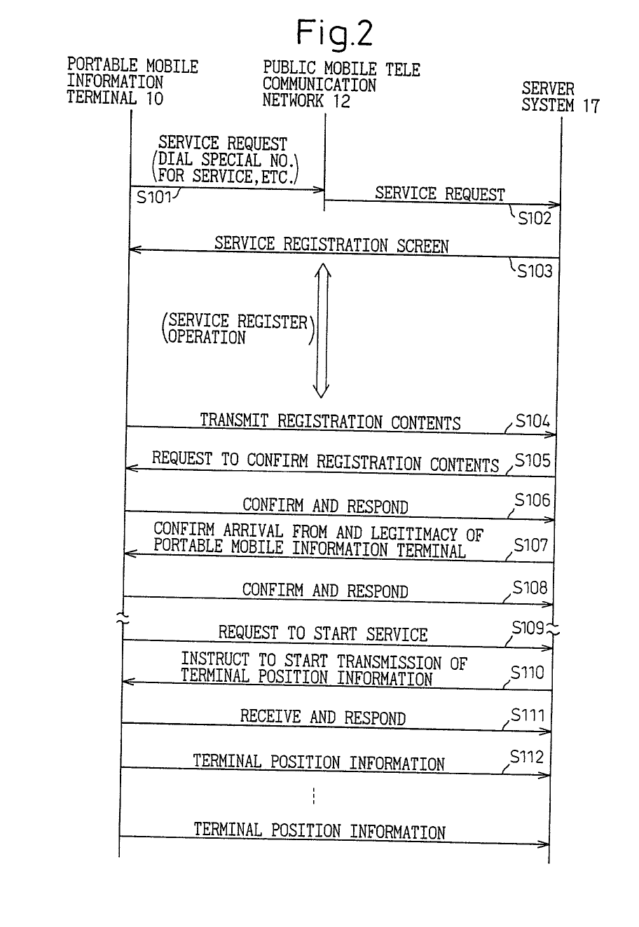

FIG. 2 shows an example of the sequences from the service registration by a terminal user to the starting of the service. For the user of the portable mobile information terminal 10 to enjoy the information distribution service according to this invention, registration is required in advance for receiving the service. In the description that follows, the sequence for service registration from the portable mobile information terminal 10 is taken up as an example. Nevertheless, the service can be registered also from the terminal 16.

In FIG. 2, the user of the portable mobile information terminal 10 sends out a service request according to the invention to a base station 11n in a public mobile communication network 12 where the particular terminal exists, by dialing a special number for the particular service (S101), or by the other means. The service request is sent further through the public mobile communication network 12, the relay function 13 and the Internet 14 to the server system 17 (S102). The server system 17, upon receipt of the service request, displays a service registration screen on the display of the portable mobile information terminal 10 using, for example, the web service by the HTTP protocol (S103).

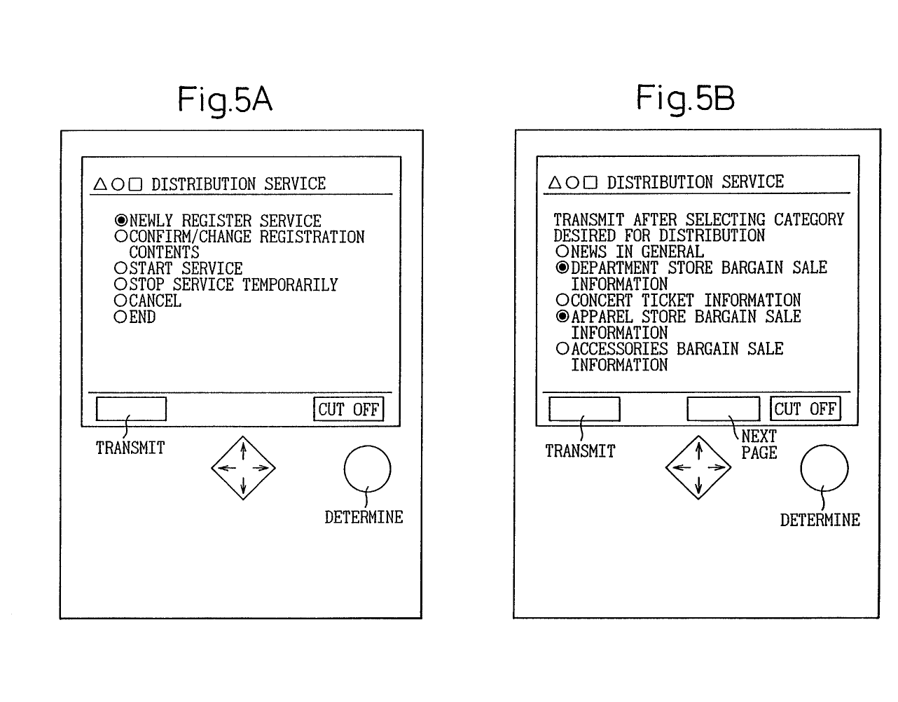

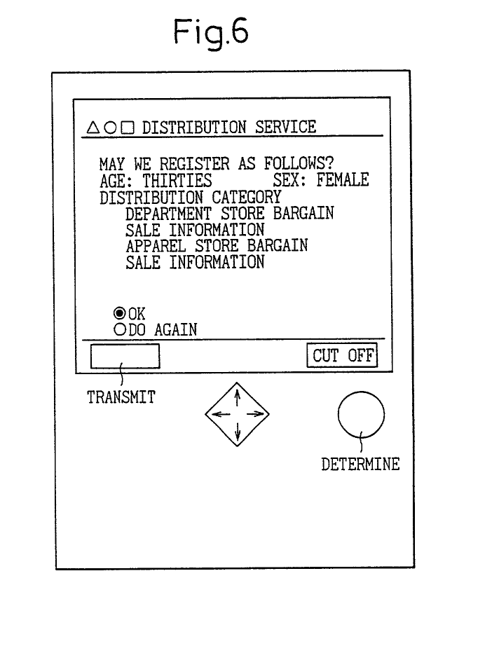

FIGS. 5A, 5B and 6 show an example of a registration menu screen displayed on the display unit of the portable mobile information terminal 10.

FIG. 5A shows an example of the large item menu screen displayed first. According to this embodiment, “NEWLY REGISTER SERVICE” is first checked. After that, a small item menu screen corresponding to various user registration items is displayed. FIG. 5B shows an registration screen of information categories of which distribution is desired as an example. In this case, “DEPARTMENT STORE BARGAIN SALE INFORMATION” is checked. Finally, as shown in the case of FIG. 6, the screen for checking the contents that have so far been registered is displayed, and by checking “OK”, the user registration procedure is completed.

Returning to FIG. 2, upon completion of the service registration operation described above, the contents of registration are transmitted to the server system 17 (S104). By the way, the aforementioned transmission process may be carried out each time of complete operation for each registration item or all the data registered can be transmitted at a time. As the next step, the contents of registration are checked between the portable mobile information terminal 10 and the server system 17 (S105 and S106). Finally, the normality, etc. of the data transmission and reception is checked between the server system 17 and the portable mobile information terminal 10 in registration (S107 and S108).

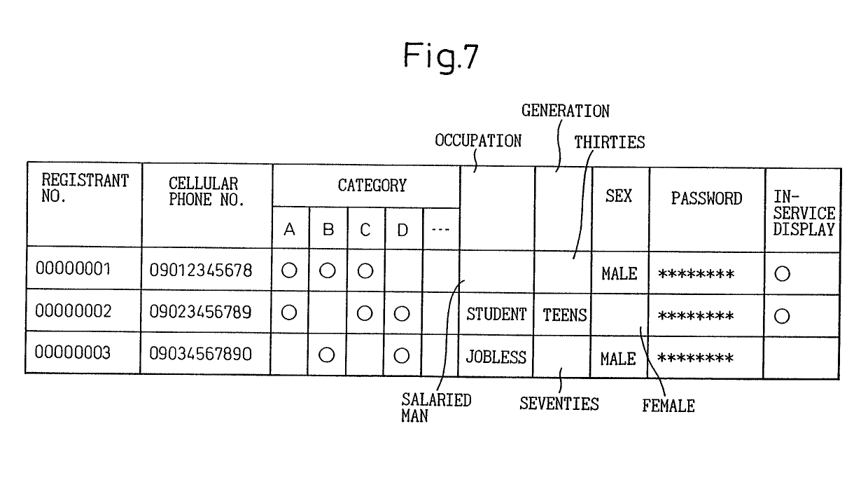

FIG. 7 shows an example of the table contents registered in the registrant master data base by the operation described above.

This table is arranged in the data base of the server system 17, and has registered therein the telephone numbers of the portable mobile information terminals 10 held by the registrants, the categories of the service requested, occupation, age, sex, password, etc. corresponding to the registrant numbers (00000001, etc.) assigned in the order of registration,. The symbol “O” in the “IN-SERVICE DISPLAY” column to the extreme right indicates that the registered service is being distributed to the user. As shown in FIG. 5B, the categories A, B, C, etc. are such that A is “NEWS”, B is “DEPARTMENT STORE BARGAIN SALE INFORMATION”, C is “CONCERT TICKET INFORMATION”, etc. In this case, the information is assumed to be distributed by the portable telephone number. Nevertheless, other means such as the mail address may alternatively be used.

As the next step, when requesting to start the service, the menu screen of FIG. 5A is displayed in the order of the special dial number, or by the other means thereby to check the “START SERVICE”. By sending this request to the server system 17, the information distribution service is started to the portable mobile information terminal 10 that has requested to start the service (S109 and S110). Upon receipt of a service start instruction, the server system 17 instructs the portable mobile information terminal 10 to activate the function of transmitting the position information autonomously (s110).

After that, the server system 17 receives the position information from the portable mobile information terminal 10 of the registered user and carries out the service distribution based on the registered contents (FIG. 7). The position information sent from the portable mobile information terminal 10 to the server system 17 includes the identification information of the base station 11 in which the particular position information is registered, or for the terminal having the GPS, the latitude/longitude information (S111 and S112).

The process of delivering to the server system the identification (ID) information of the base station 11 in which the position information of the portable mobile information terminal 10 is registered poses the following problem. In view of the prevailing fact that the information related to position registration is the internal information of the communication carrier, the particular information can be used only when it is disclosed by the common carrier. Currently, therefore, the position information services are provided in most cases by the common carrier itself, or by combining a position measuring device such as a GPS receiver with the cellular phone or PHS and transmitting the position information such as the latitude/longitude to the server system 17 regardless of the common carrier.

At the portable mobile information terminal 10 based on the specification of “IMT2000” constituting the next-generation mobile communication system, however, the protocol for handling the position information is standardized. Therefore, the position information of the terminal itself can be sent out to the server system using the upper layer protocol regardless of the common carrier or whether the portable mobile information terminal 10 has an independent position measuring function or not.

By the way, the portable mobile information terminal 10 can be adapted to transmit the position information to the server system 17 each time it is moved to another control area of the common carrier or at regular intervals of time, as shown in FIG. 2. Also, the portable mobile information terminal 10 is preferably capable of temporarily stopping/restarting the transmission of the position information thereof by the independent operation of itself in a predetermined case required of the terminal user for confidentiality or the like. This is also the case with the server system 17, which is preferably capable of temporarily stopping/restarting, for each terminal user, the seeking of the position information of or the information distribution to a predetermined registered user in a predetermined case.

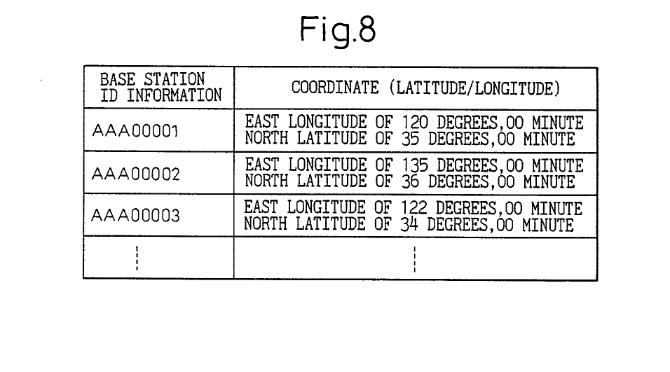

FIG. 8 shows an example of the position information table based on the latitude/longitude held in the data base of the server system 17.

This table has stored therein the coordinate information (120 degrees 00 minute of east longitude, 35 degrees 00 minute of north latitude, etc.) including the latitude/longitude in the right column corresponding to the radio base station ID information (AAA00001, etc.) in the left column. The server system 17, upon receipt of the position registration information based on the base station ID information from a portable mobile information terminal 10 having no position measuring function, determines (as described later) the latitude and longitude of the particular portable mobile information terminal 10 with reference to the table described above. The latitude/longitude information, however, is received directly from the portable mobile information terminal 10 having the position measuring function.

In this way, in the case where the position information from a portable mobile information terminal 10 is the base station ID information of a given common carrier, for example, the data base of the server system 17 has the function of setting the particular ID information in correspondence with the latitude/longitude. Such a data base is constructed before starting the service and the table of contents thereof are updated appropriately.

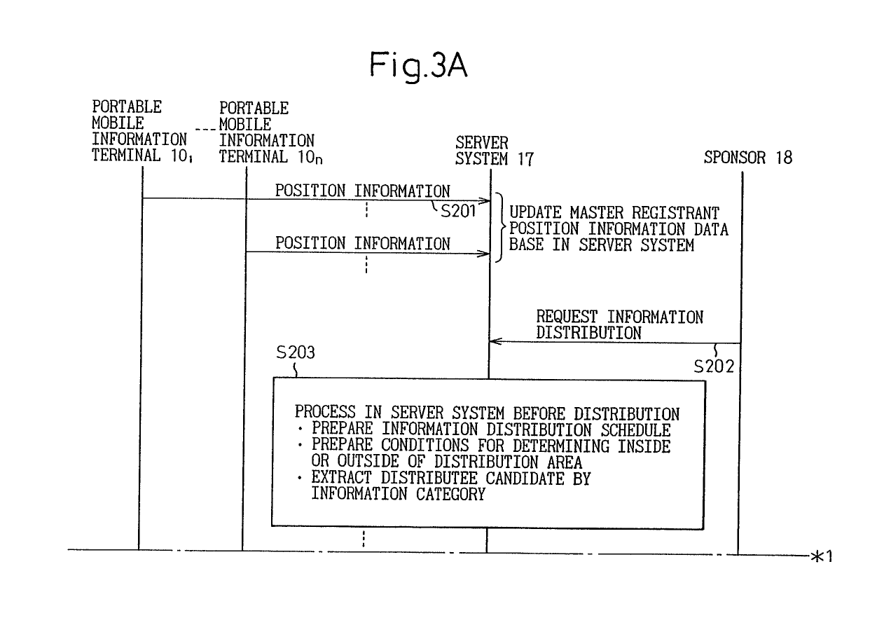

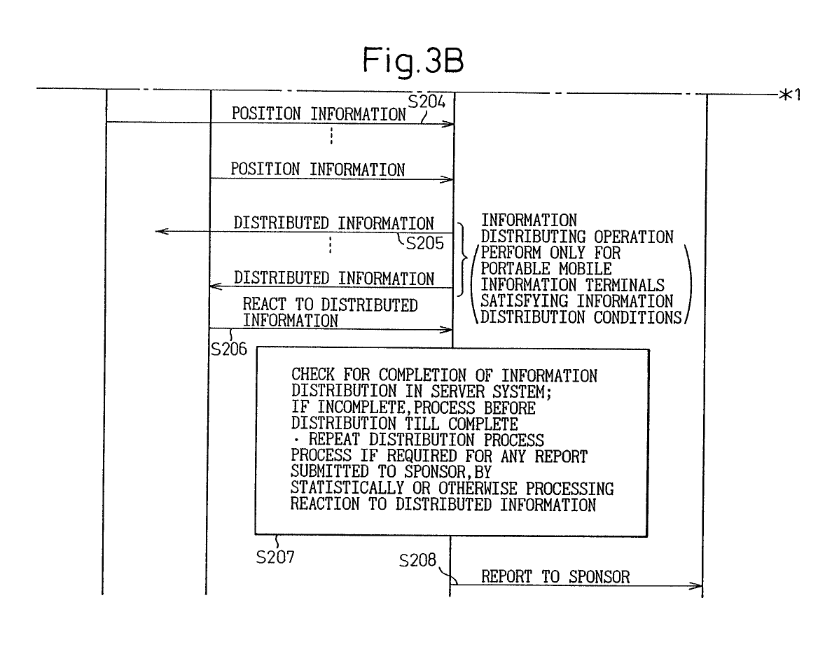

FIG. 3 shows an example of the sequence for the request mainly from the information provider to distribute information. The request for information distribution is the matter of a contract between the server system operator and the sponsor. The description that follows refers to the on-line request for information distribution as an example.

In FIG. 3, first, the sponsor 18 sends an information distribution request including the information to be distributed and the information designating the distribution conditions to the server system 17 (S202).

According to this invention, the information to be distributed and the conditions for specifying the distribution area are essential. As shown in FIG. 7, the conditions for limiting the distributes by category, generation, etc. can also be indicated expressly. The conditions for specifying an area to which information is distributed include the information for specifying the center and the boundary of the area.

For example, totalization may be required of the statistical information including the response to such factors as (a) geophysical conditions (designation by such wordings as “near 00 station”, “near 00 department store”, “along 00 street”, or administrative districts such as the 23 wards of Tokyo, Kawasaki city, Kanto district, etc.), (b) preferences, taste, (c) occupation, (d) sex, (e) time zone to be distributed, (f) number of times to be distributed, and (g) information to be distributed. The condition “not limited” may also be included as a special case. In the case of the condition that “geophysical conditions not limited”, for example, indicates that information is to be distributed to wherever the portable mobile information terminal 10 is currently located. The announcement of sale of an entertainment ticket throughout the country is a specific example.

The server system 17, at the request from the sponsor 18, stores the received information to be distributed and the distribution conditions in the internal data base for managing the received information or updates the contents of the existing information as the preliminary processing for information distribution (S203). This process includes the following steps:

(1) The portable mobile information terminal 10 of each registrant meeting the distribution conditions (geophysical and other conditions) stored in the received information management data is selected from the registrant data base or the position information table (FIGS. 7 and 8).

(2) Among the distribution conditions in the received information management data base, the conditions not included in the registrant base data such as the temporal conditions and the number of times are evaluated and an appropriate process is executed correspondingly, or in the case where a time point is designated, the preparatory process is executed therefor.

(3) Further, terminals satisfying the conditions (2) are selected from the terminals selected in (1), and the information is distributed to the portable mobile information terminals 10 finally selected (S205).

(4) The contents of the received information management data base are updated by the distribution of the information, and in the case where a plurality of times of distribution is specified as a condition, the distribution process is carried out an additional required number of times until the conditions for completion are met (S207).

(5) If required, the statistical data for information distribution and the data on the questionnaires for the information distributed from the terminal users are totalized (S207).

In such a case, the prepared information to be distributed contains some means for requesting the response of the information receivers (the questionnaire form or the page of a specific site of the server system 17 is displayed to induce the response to them, for example), and the server system 17 is equipped with means capable of recognizing the response (S207). The responses are totalized and processed on the conditions designated by the sponsor 18 and delivered to the sponsor 18, or posted on a specific site or the like using such means as the Internet for permitting reference by the sponsor 18. (S208).

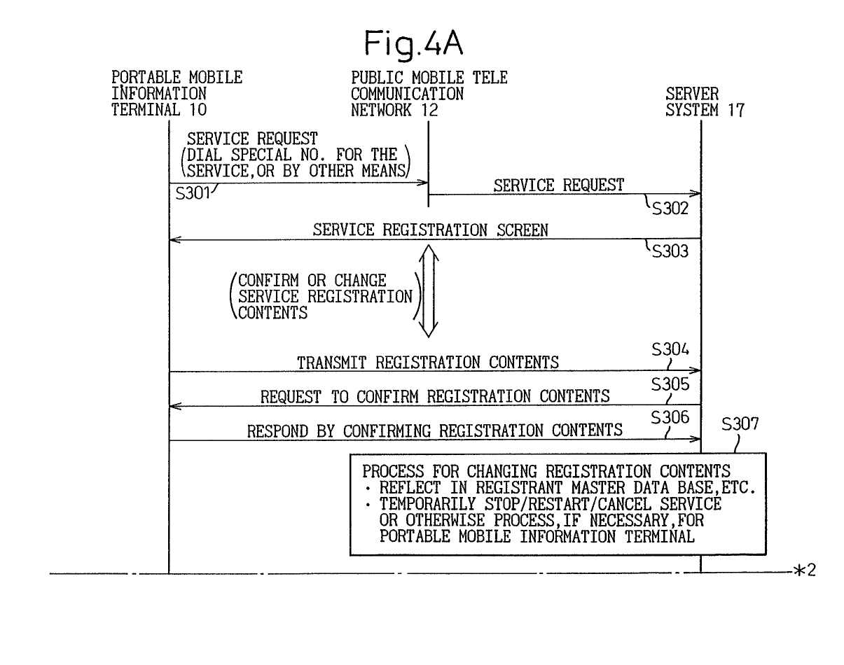

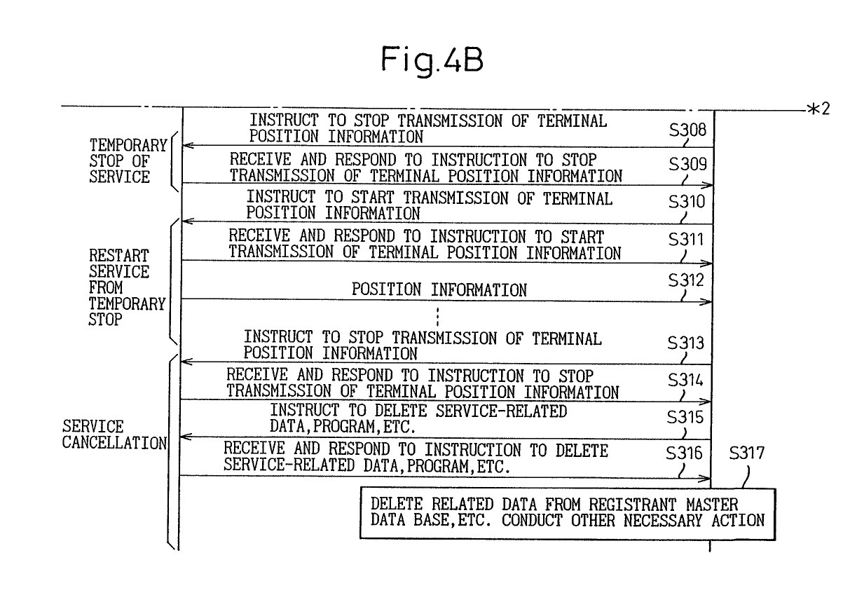

FIG. 4 shows an example of the complementary sequences of changing the service contents by the terminal user.

In FIG. 4, the user of the portable mobile information terminal 10 first sends out a service request according to the invention, by dialing a specific number for the particular service, to the base station 11n in the public mobile communication network 12 where the particular terminal exists, or by the other means. The service request is then sent to the server system 17 through the public mobile communication network 12 or the like (S302). The server system 17, upon receipt of the service request, displays a service registration screen on the display unit of the portable mobile information terminal 10 using, for example, the web service or the like according to the HTTP protocol (S303).

The terminal user checks “CONFIRM AND CHANGE REGISTRATION CONTENTS” in FIG. 5A according to this embodiment, and selecting the contents of the service change on the small item menu screen or the like opened subsequently, sends the contents of change to the server system 17 (S304). Then, the process of confirming the contents of change is carried out between the portable mobile information terminal 10 and the server system 17 (S305 and S306). According to the received contents, the server system 17 updates the distribution conditions in the registrant data base and the received information management data base or executes the preliminary processing operation required by the change (S307).

Steps S308 to S312 represent an example of the sequence of the temporary stop of service to the restart thereof conducted under the instruction of the server system 17 in the case where the change mentioned above is a service temporary stop request or a restart request issued from the terminal user. The server system 17 that has accepted the change of the service temporary stop instructs the portable mobile information terminal 10 to stop transmission of the position information (S308), and thereby changes the data base so that no information may not distributed to the particular portable mobile information terminal 10 (see the in-service display in FIG. 7). The server system 17 that has accepted the change of the service restart request, on the other hand, instructs the portable mobile information terminal 10 to start transmission of the position information (S310) and changes the data base so that the information may be distributed to the particular portable mobile information terminal 10 (FIG. 7).

Also, steps S308 to S312 represent an example of the service cancel sequence conducted under the main control of the server system 17 in the case where the change is the service cancel requested by the terminal user. In this case, like the change of the service temporary stop request described above, the portable mobile information terminal 10 is instructed to stop transmission of the position information (S313), after which the service-related programs and data held in the portable mobile information terminal of the canceling user are deleted (S315 and S316). At the same time, the information of the canceling user is deleted from the master data base or the like of the server system 17, and the post-processing required for this procedure is executed (S317).

Now, an explanation will be given of several examples of the process performed by the server system 17 for determining the persons (the registered users of the portable mobile information terminal 10) to which the prepared information is to be distributed.

As apparent from the foregoing description, according to this invention, the most crucial job of the server system 17 is to extract, from the mass of the registrant users, the portable mobile information terminals 10 of the registrant users existing in the area covered for information distribution. For this purpose, the server system 17 for providing the information distribution service can determine by the method described below, for example, whether a given portable mobile information terminal 10 is a predetermined target terminal for information distribution.

The following description assumes that the latitude/longitude information is used as the position information of a portable mobile information terminal 10. This is possible as long as the portable mobile information terminal 10 has an independent position measuring function or a function to measure the position in collaboration with the public mobile network. Depending on the public mobile communication network system or the position measuring method for the portable mobile information terminal, the latitude/longitude information may not be directly obtained. Even in such a case, however, suppose that the latitude/longitude information of the portable mobile information terminal can be obtained by assuming that the latitude/longitude of a base station having stored therein the portable mobile information terminal 10 is registered is regarded as the position information of the portable mobile information terminal 10 based on the ID information of the particular base station or some other means.

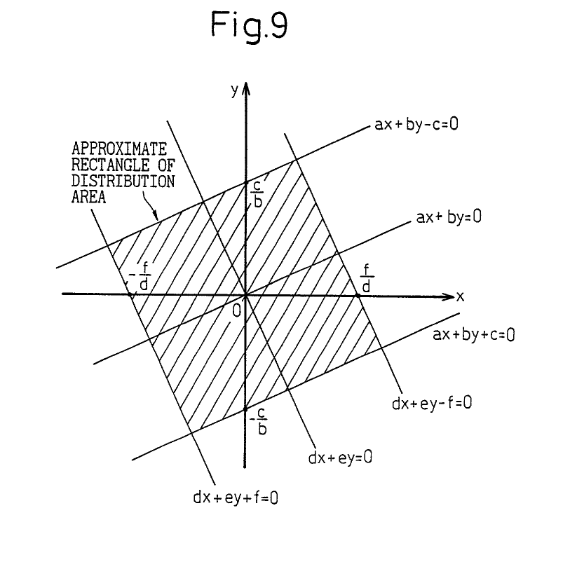

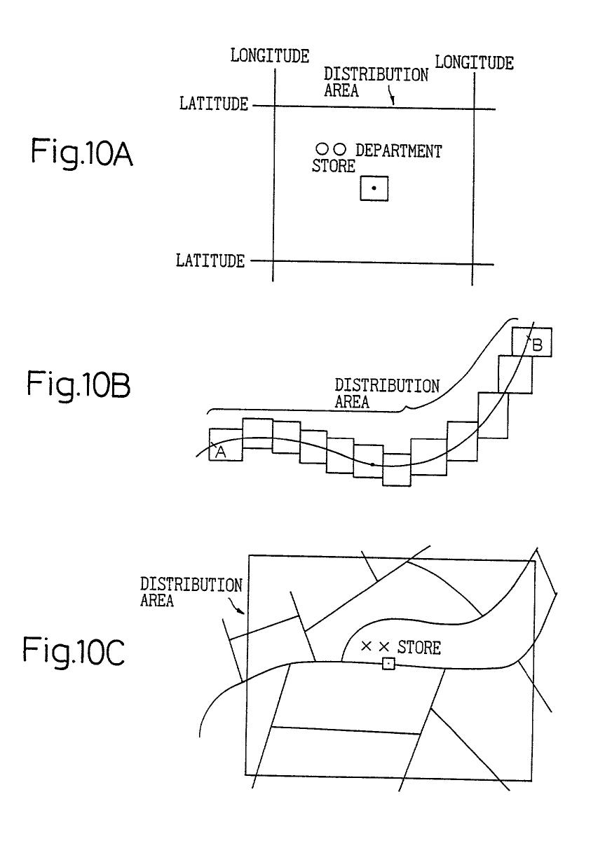

FIGS. 9 and 10A to 10C show an example in which a rectangular area is used as an area in which information distribution is intended for.

In FIG. 9, the area covered for information distribution is considered as a rectangular area, and by arranging an appropriate position at the center (0, 0) of the x-y coordinate, the four straight lines constituting the outer frame are defined as follows:

ax+by+c=0

ax+by−c=0

dx+ey+f=0

dx+ey−f=0

where the line given by ax+by+c=0 and the line given by ax+by−c=0 are parallel to each other, and so are the line expressed by dx+ey+f=0 and the line expressed by dx+ey−f=0. The values a, b, c, d, e, f are set in such a manner that the two sets of the straight lines are perpendicular to each other. In a special case, the straight lines with x as a constant and y as a constant may be combined. According to this embodiment, whether a given portable mobile information terminal in an area can enjoy the service or not is determined according to whether the latitude/longitude information received from the particular terminal is located in the hatched area of FIG. 9 or not. The conversion of the coordinate system and the aforementioned determination are mathematically easy to accomplish.

FIGS. 10A to 10C show several examples of other applications of a rectangular area in the server system 17. In this case, assume that the process of other than determining the position information of an intended distributee, such as the selection of information of the category of distribution services, for example, is complete. The server system 17 determines a rectangular area of an appropriate size for covering the area intended for information distribution based on the information distribution conditions from the information provider 18, and thus determines the equations for the four straight lines constituting an outer frame.

FIG. 10A shows an example of the case in which an area “WITHIN O MINUTES' WALK FROM OO DEPARTMENT STORE CONDUCTING BARGAIN SALE” is designated by the sponsor 18. A square of O m each side with the position of “OO DEPARTMENT STORE” as the center is regarded as a target area, and the corresponding latitude/longitude lines are used as the four straight lines. This corresponds to the combination of straight lines of the constant x and the constant y in FIG. 9.

FIG. 10B shows an example of the case in which an area “FROM POINT A TO POINT B ALONG A CERTAIN TRUNK ROAD” is designated by the sponsor 18. In this case, basically, the method in which the specified trunk road is segmented into several sections of a short distance and a rectangular area is arranged for each of the sections, can reduce the error between the area intended for distribution and the actual distribution area. Depending on the route of the roads and the size of the allowable error, however, a longer distance may be set for each section. In most simplistic fashion, a range having an appropriate width about the straight line connecting points A and B can be considered as an area intended for distribution.

In similar fashion, FIG. 10C shows an example of arranging rectangular areas along a road within OO km from XX store. With regard to each example described above, instead of calculating the rectangular area or setting a manual in the server system 17 each time an area designation is requested, an area setting menu or list to meet the expected requests may be prepared in the server system 17. The “NEAR SHIBUYA STATION”, for example, is accompanied by the setting “RANGE OF OO DEGREES OO MINUTES OO SECONDS TO OO DEGREES OO MINUTES OO SECONDS OF NORTH LATITUDE, AND OO DEGREES OO MINUTES OO SECONDS TO OO DEGREES OO MINUTES OO SECONDS OF EAST LONGITUDE”.

Based on the position information from the portable mobile information terminal 10 constituting a candidate distributes of information extracted in advance, the server system 17 determines in which of the rectangular areas set in each example of FIG. 10 immediately before the time of information distribution the coordinate of the particular position information is included. According to this determination, the portable mobile information constituting the final information distributee is extracted and determined, and individual, specific information are distributed to the particular portable mobile information terminal.

In FIGS. 9 and 10A to 10C, an embodiment is described based on the idea that the area to which information is to be distributed is approximated by a single or a plurality of simple figures. The primary object of this approximation is to simplify the process on the part of the server system 17. Nevertheless, this approximation is proper also in other aspects. Several reasons for this will be verified below.

First, the position information itself from the portable mobile information terminal 10 contains an error of several hundred meters at maximum. The use of such position information in an attempt to determine the inside and outside of an area strictly by determining the boundary of an “AREA TO WHICH INFORMATION TRANSMISSION IS DESIRED” designated by the sponsor 18 often results in a determination failure. The degree to which the determination is erroneous remains substantially unchanged even in the case where the target area is approximated by a simple figure.

Assume, for example, that “RANGE WITHIN 20 MINUTES' WALK TO OO DEPARTMENT STORE” is designated as shown in FIG. 10A. If this desire is to be faithfully realized, the range accessible at the average walking speed of 4 km/h should be determined as a target area taking all the neighboring roads into account. Determination of the boundary of the target area is a very complicated process when considering the presence or absence of slopes as well as the shape of the roads, thereby unavoidably leading to the complicated equations of the polygons and the curves expressing the area boundary. The process of determining the outside and inside of the target area using this result and the latitude/longitude information of the terminal is also complicated. In spite of this, an error still exists and the possibility of making error in determining the inside or outside of the target area cannot be eliminated.

In this service, the probability of making an error of determining that a terminal actually existing inside of a target area is located outside of the target area should be reduced. A solution to this problem may be to add an area as wide as the error to the outside of the target area determined previously. By doing so, a terminal actually existing outside of the target area may be determined erroneously as existing inside of the target area. Nevertheless, the probability of making error in determining that a terminal actually existing inside of the target area as existing outside of the target area can be reduced substantially to zero. In this case, the shape of the target area becomes similar to a rectangle or a circle as the result of the initial irregularities of the shape being smoothed.

By setting a wider target area initially using a rectangle or a circle, therefore, the processing load of the server system can be reduced without adversely affecting the interests of the sponsor 18.

In this case, the portable mobile information terminal 10, which is an object of information distribution, may be relocated during the process of determination of the inside or outside of the target area and the following actual distribution. Specifically, during this time interval when the portable mobile information terminal 10 may enter or leave the target area, the sponsor 18 can expect a higher effect of his announcement by distributing information over a somewhat wider area than the target area. At least from this point of view, the strict area definition is meaningless.

Further, the error of the position information is varied from one position measuring method to another, and therefore the error of the various terminals to be serviced cannot be limited to one category. In the case where the position measurement error is small, it may be effective to define the boundary strictly in a way faithfully complying with the conditions as of the time of provision of the information with an accuracy corresponding to the degree of the error. An attempt to provide a service only to portable mobile information terminals having a small error, however, makes it necessary to identify the type of each terminal and complicates the processing in the server system 17. The resulting increased load and the increased consumption of the system resources increases the amount of the fee charged for information distribution. Generally, the sponsor 18 is considered to expect a higher effect with a lower cost.

For the reason described above, it is considered that no special problem is posed by some error of position measurement or the information distribution out of the target area. Further, the approximation method for covering simple rectangular areas shown in FIGS. 9 and FIGS. 10A to 10C simplifies the processing of the server system 17 and solves the cost problem. By the way, the surface of the globe is not flat, and therefore the rectangle referred to in this embodiment is not a rectangle in the strict mathematical sense of the word. Nevertheless, the error is negligible considering the error of position measurement and the characteristics of the mobile communication.

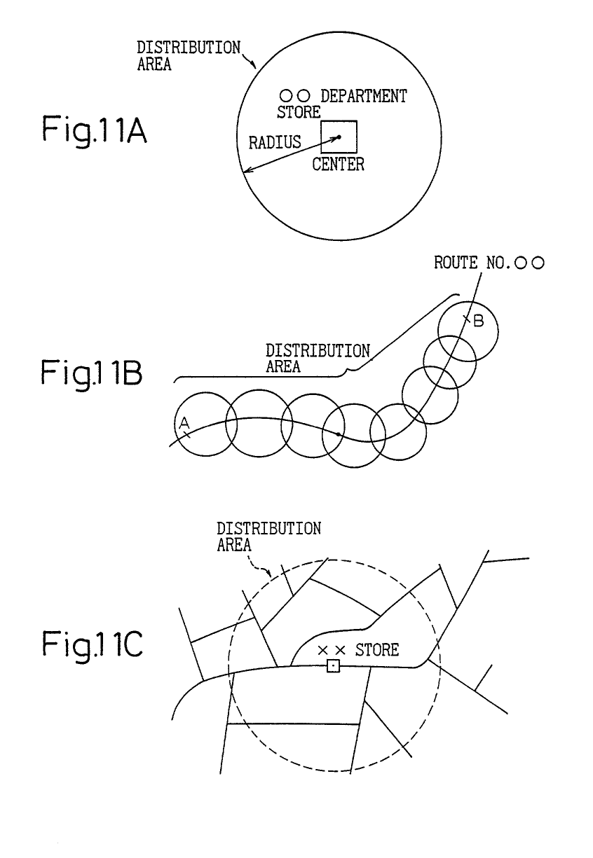

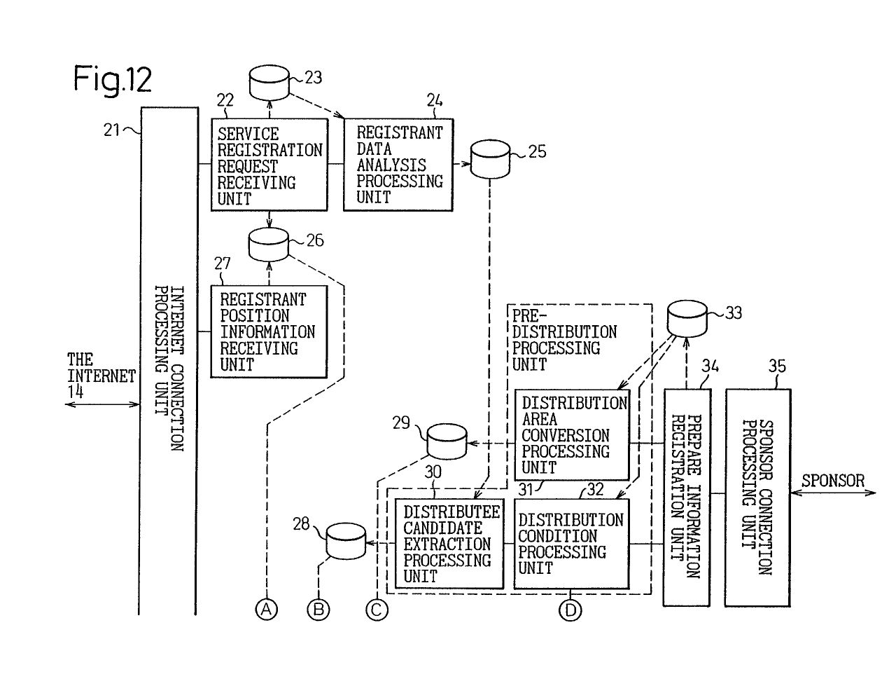

FIGS. 11A to 11C show the case in which a circular area is used for information distribution as another example of a simple way of area setting. FIGS. 11A to 11C correspond to FIGS. 10A to 10C, respectively. In this case, a circular area is considered in place of a rectangular area covering the target area of information distribution, and the distance is calculated based on the central point of the circle and the coordinate of the portable mobile information terminal 10. In the case where the distance is smaller than the radius of the corresponding circle (the terminal is located inside of the circle), the particular terminal is determined to exist within the target area. This determination is easily accomplished mathematically.

On the other hand, an attempt to cover the target area with a single circle may cause a considerable displacement from the area intended for by the sponsor 18. Specifically, in the case where it is determined that a considerable part of the area not intended for distribution is included in the single circle, the target area can be more suitably covered by combining a plurality of smaller circles (unit circles). Whether the portable mobile information terminal 10 exists in the target area or not is determined by checking whether it is included in any one of the unit circles. The other points are similar to those of the rectangular area shown in FIGS. 10A to 10C and will not be described further.

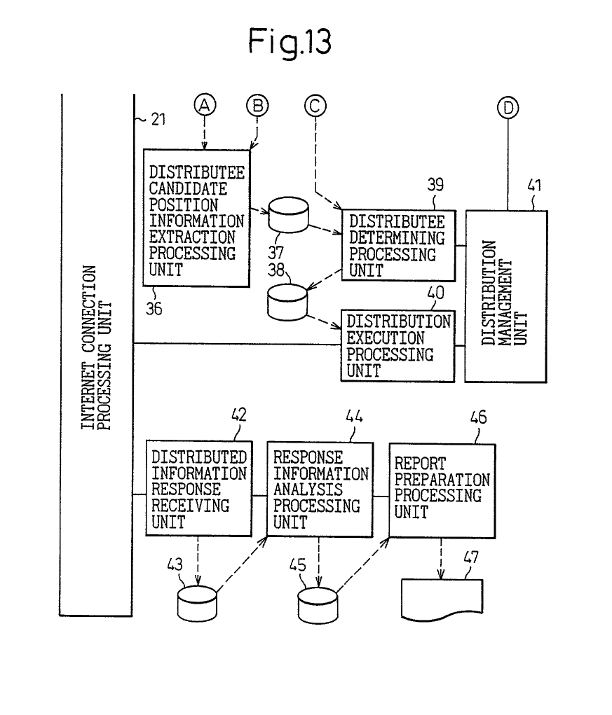

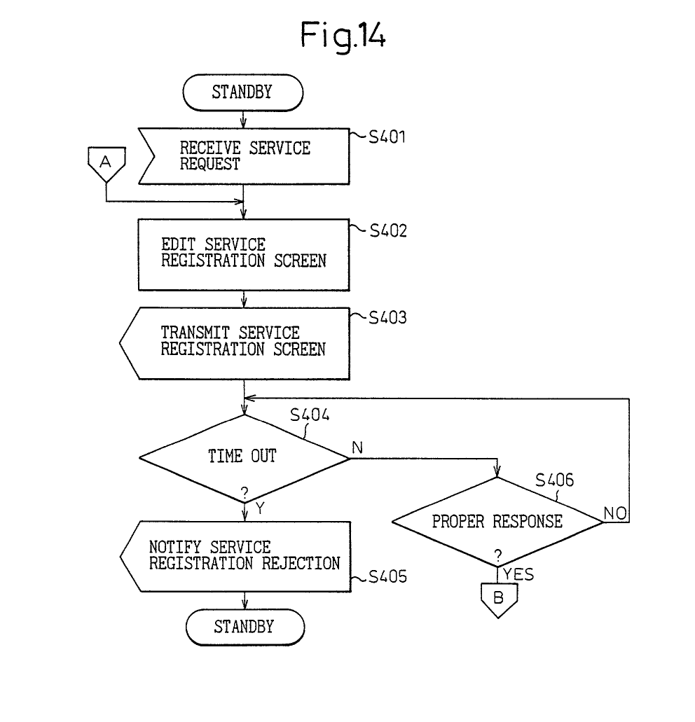

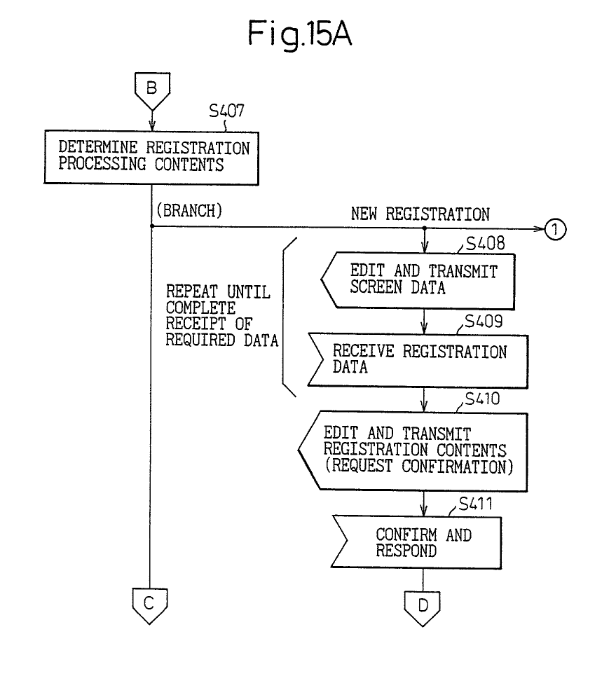

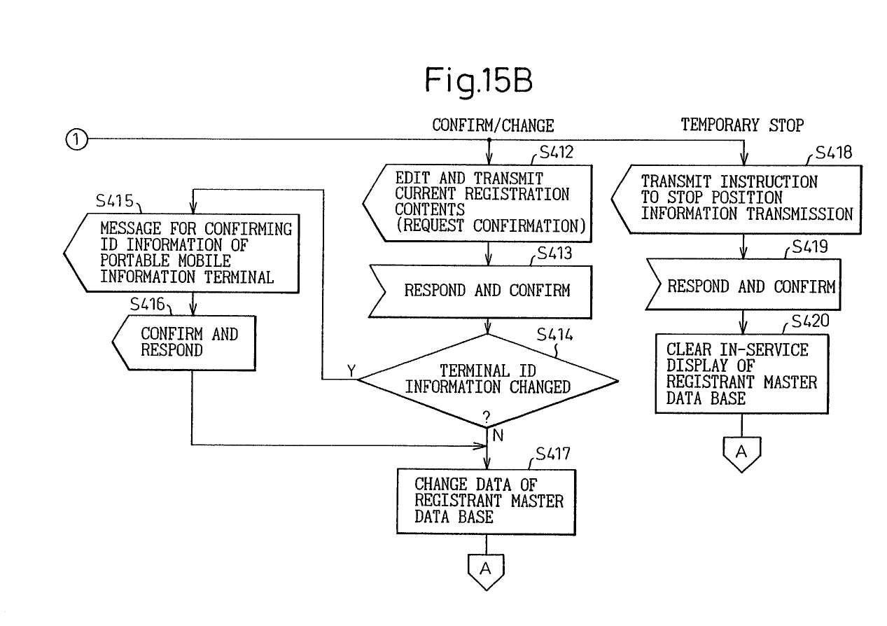

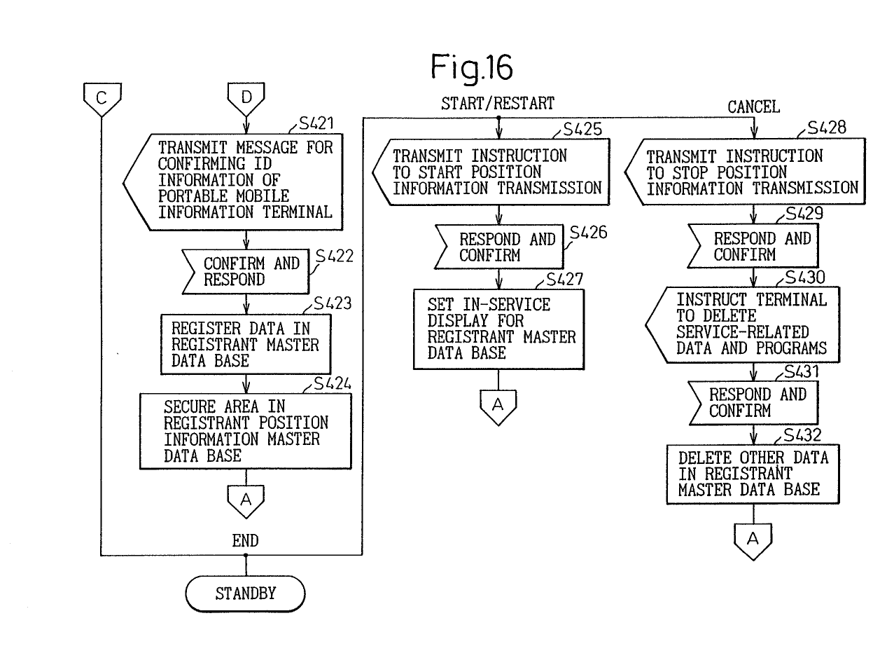

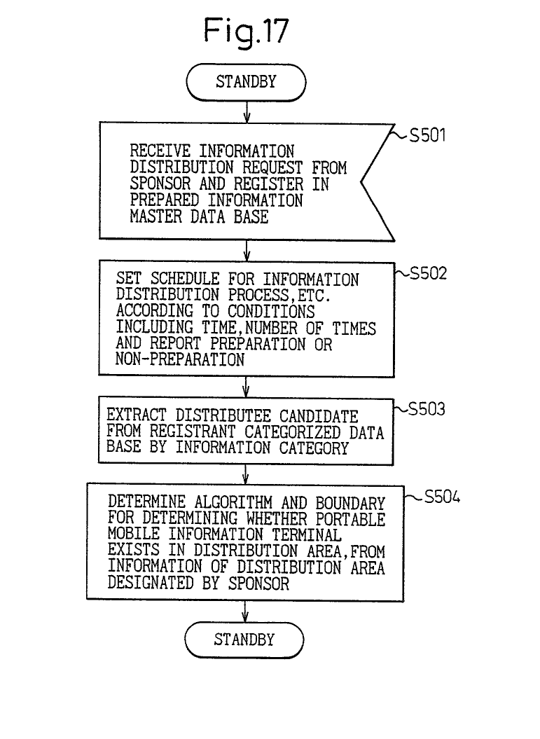

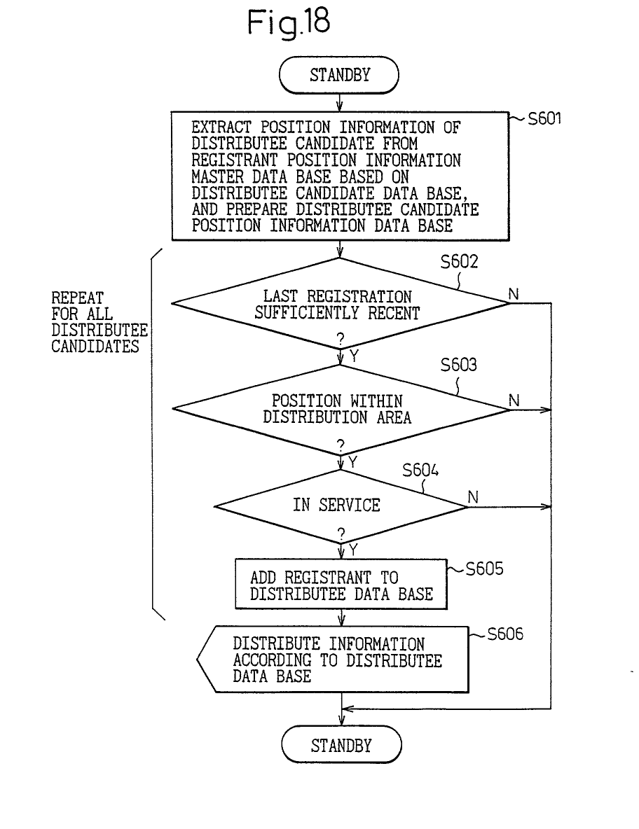

FIGS. 12 and 13 show an example of a configuration of the server system 17 according to this invention. FIGS. 14 to 18 show an example of the control flow in the server system 17. The component elements of the server system 17 and the functions thereof will be explained below by referring to FIGS. 14 to 18 collectively.

The Internet connection processing unit 21 transmits and receives the information mainly to and from the portable mobile information terminal 10 through the Internet 14, and delivers the received data to the corresponding processing unit in accordance with the contents of the data received.

A service registration request receiving unit 22 receives a processing request for such as a new registration or a change of the service from the portable mobile information terminal 10, and causes a registration menu screen to be displayed on the display unit of the portable mobile information terminal 10 (S401 to S407). Also, the processing result corresponding to each request type is stored as new registration data in a registrant master data base 23 (S408 to S411, S421 to S424), or the existing registration data are updated correspondingly (S412 to S417).

Also, a confirmation message is sent to the portable mobile information terminal 10 and the response is confirmed. (S411, S413, etc.). Further, in accordance with the processing result described above, the operation is performed for temporarily stopping, canceling or otherwise processing the service (S418 to S420, S425 to S432). By the way, in the case of a new registration, an area corresponding to the registrant is secured in the registrant position information master data base 26. The registrant data analysis processing unit 24 classifies the data of the registrant master data base 23 into various categories (bargain sale information, news, etc.) the distribution of which the registrant desires, and the classification result is recorded in the data base 25 by registrant category.

The information provider connection processing unit 35, on the other hand, receives the prepared information and the distribution conditions from the information provider (S501). By the way, this embodiment assumes a configuration in which the prepared information and the distribution conditions requested by the information provider are input to the server system 17. Nevertheless, the request can of course alternatively be received on-line through the Internet 14 by a configuration similar to the service registration request receiving unit 22, etc. described above.

The prepared information registration unit 5 registers the prepared information and the distribution conditions received from the sponsor 18 in the prepared information master data base 33 (S501). The processing before distribution is executed by the distribution area change processing unit 31, the distribution conditions processing unit 32 and the distributes candidate extraction processing unit 30. The distribution area change processing unit 31 retrieves the conditions designating the distribution area from the distribution conditions registered in the prepared information master data base 33, and based on the position information from the portable mobile information terminal 10, generates the conditions for determining whether the corresponding terminal exists in the distribution area. These conditions are recorded in the distribution area data base 29 (S504).

Also, the distribution conditions processing unit 32 determines, from the distribution conditions registered in the prepared information master data base 33, whether the temporal distribution conditions (date/time, number of times, etc.) and the response to the distribution are required to be processed and generates a distribution schedule (S502). The result is managed by the distribution management unit 41. Further, the conditions for the information category are extracted and delivered to the distributes candidate extraction processing unit 30.

The distributee candidate extraction processing unit 30 extracts, from the registrant categorized data base 25, service registrants to which the information can be distributed, using the conditions for the category of the particular information, and records them in the distributes candidate data base 28 (S503).

The distributee candidate position information extraction processing unit 36 retrieves the latest position information from the registrant position information master data base 26 for the registrants in the distributes candidate data base 28, and records them in the distributes candidate position information data base 37.

The distribution management unit 41 determines the distributees appropriately by adjusting the scheduling of various information distribution requests, and executes the distribution processing. Immediately before the time point of information distribution according to the distribution schedule managed by the distribution management unit 41, the distributee determination processing unit 39 checks to see that each data in the distributee candidate position information data base 37 is the latest information and that the services are being provided. By so doing, only the portable mobile information terminals 10 existing in the distribution area are recorded in the distributee data base 38 using the distribution area data base 29 (S601).

The distribution execution processing unit 40, under the control of the distribution management unit 41, distributes the corresponding individual and specific information through the Internet connection processing unit 21 to the portable mobile information terminals 10 of the registrants recorded in the distributee data base 38 (S602 to S606). The distributed information response receiving unit 42 receives the response, if any, of the service registrant to the distributed information through the Internet connection processing unit 21, and records the response in the response information master data base 43.

The response information analysis processing unit 44 performs the effect measurement, statistic processing, analysis and other required processes on the response data from the service registrants recorded in the response information master data base 43, and records the result thereof in the analysis totalization log master data base 45. The report production processing unit 46 edits by illustrating or otherwise processing the contents recorded in the analysis totalization log master data base 45, and thus prepares the report 47 to the sponsor 18. By the way, the report 47 is prepared in the form of a printed document or an appropriate electronic medium or by using an appropriate communication means.

As described above, according to this invention, the portable mobile information terminal autonomously transmits the position information thereof (specifically, the registration area information of the mobile communication network, the ID code of the base station in registration, the position information obtained by use of the position measuring system such as GPS, etc.) to the server system. The server system, in turn, manages the particular position information in collaboration with the registrant data base including the individual registered user information while at the same time using the prepared information provided from the sponsor as conditions for selecting the information distributee based on the particular position information.

In this way, in the case where information distribution is requested, the position information for the current existence in target area, in addition to the preferences, etc. of the terminal user in registration, is used for selecting the distributee. Therefore, the information distribution having a high announcement effect closely related to the particular area is made possible.

Specifically, the significant information distribution (advertisement, publicity, etc.) is made possible by the sponsor only to the terminal users existing in a specific area at a given time point, thereby probably making possible a remarkable improvement of the announcement effect.

The terminal user who receives the distributed information, on the other hand, also can acquire the interesting information directly or otherwise related to the current situation (area, time, etc.). As a result, a secondary effect is obtained by which the terminal user is released from a wasteful flood of information or the job of selecting information therefrom.

1. A server system for distributing information to portable mobile information terminals in a specific area, comprising:
a first data base for storing the information of the specific area where the information distribution service is provided to registered users of the portable mobile information terminals;
a second data base for storing prepared information to be distributed and distribution conditions provided by an information provider;
a third data base for storing the registered users and the conditions for receiving the distributed information;
means for receiving position information from the portable mobile information terminals of said registered users;
determining means for determining whether said received position information is located in a specified area stored in said first data base; and
information distribution means for distributing the prepared information satisfying the distribution conditions stored in said second data base and the receiving conditions of said users stored in said third data base, to the portable mobile information terminals of said users determined by said determining means to be located in said area.

2. A server system as described in claim 1, further comprising area determining means for illustrating said specific area using a simple figure, and storing said figure in said first data base as area information indicated by the latitude and longitude;
wherein said determining means uses the position information received from said portable mobile information terminals for said determination.

3. A server system as described in claim 1, wherein said position information received from said portable mobile information terminals is the latitude/longitude information of said portable mobile information terminals.

4. A server system as described in claim 3, further comprising area determining means for illustrating said specific area using a simple figure, and storing said figure in said first data base as area information indicated by the latitude and longitude;
wherein said determining means uses said latitude/longitude information received from said portable mobile information terminals for said determination.

5. A server system as described in claim 3, wherein said latitude/longitude information is given by the portable mobile information terminals having a GPS receiver.

6. A server system as described in claim 1, wherein said position information received from said portable mobile information terminals is the information on the base station of a radio area where each of said portable mobile information terminals is existent.

7. A server system as described in claim 6, further comprising area determining means for illustrating said specific area using a simple figure, and storing said figure in said first data base as area information indicated by the latitude and longitude;
wherein said determining means uses, for its determination, the latitude/longitude information converted based on the base station information of the radio area where said portable mobile information terminal exists, which station information is received from said portable mobile information terminal.

8. A server system as described in claim 1, further comprising registration/canceling/change means for executing, by communication with each of said portable mobile information terminals, the registration/canceling procedure for the user registration of the portable mobile information terminal and the registration/change procedure for the receiving conditions of said user stored in said third data base.

9. A server system as described in claim 1, further comprising receiving means for receiving the distributed information and the conditions for information distribution provided by said sponsor and storing said information and said receiving conditions in said second data base.

10. A server system as described in claim 1, further comprising means for receiving the response of a registered user to the distributed information, recording and statistically processing said response, and managing and maintaining the result of said process.
